(19) United States
(12) Patent Application Publication
(10) Pub. No.: US 2026/0257156 A1
(43) Pub. Date: Sep. 3, 2026

(54) Filter Element

(71) Applicant: HYDAC Filtertechnik GmbH, Sulzbach / Saar (DE)

(72) Inventors: Volker Backes, Marpingen (DE); Dirk Röder, Saarbrücken (DE); Lars Hegmann, Friedrichsthal (DE); Pascal Toussaint, St. Ingbert-Rentrisch (DE)

(73) Assignee: HYDAC Filtertechnik GmbH, Sulzbach / Saar (DE)

(21) Appl. No.: 19/135,313

(22) PCT Filed: May 31, 2024
(86) PCT No.: PCT/EP2024/065000

§ 371 Date: Jun. 3, 2025

(30) Foreign Application Priority Data
Jun. 22, 2023 (DE) 10 2023 002 529.1

(51) Int. Cl. B01D 29/13; B01D 35/147

(52) U.S. Cl. CPC B01D 29/13; B01D 35/147; B01D 2201/167; B01D 2201/295; B01D 2201/4046

(57) ABSTRACT

The disclosure relates to a filter element comprising an element material which delimits an interior and which extends between two closure parts, one closure part thereof having a spherical bearing and a fluid-conducting connection part which leads in the direction of the interior. The other closure part has at least one control surface, each of which holds the element material in an installation position relative to the connection part in a non-actuated state and each of which brings the element material into a functional position, which is collision-free for the filter element, relative to the connection part by means of the spherical bearing in an actuated state.

### CROSS-REFERENCE TO RELATED APPLICATIONS

This application claims priority to German Patent Application DE 10 2023 002 529.1, filed on Jun. 22, 2023 with the German Patent and Trademark Office. The contents of the aforesaid Patent Application are incorporated herein for all purposes.

### BACKGROUND

This background section is provided for the purpose of generally describing the context of the disclosure. Work of the t presently named inventor(s), to the extent the work is described in this background section, as well as aspects of the description that may not otherwise qualify as prior art at the time of filing, are neither expressly nor impliedly admitted as prior art against the present disclosure.

The disclosure relates to a filter element comprising an element material, which defines an interior and which extends between two end parts, one end part of which has a spherical bearing and a fluid-conducting connecting part which opens out in the direction of the interior.

DE 10 2018 009 187 A1 discloses a filter device with a filter housing and a filter element accommodated therein, the element material of which extends between two end caps as the two end parts, of which at least one end cap is mounted on an element holder, the filter element being articulated on the element holder via its one end cap by means of a bearing which provides more than one degree of freedom. The known solution is designed as a so-called in-tank solution with an inflow opening for unfiltered medium, which is integrated in a filter head, which filter head fixes the filter device to a tank wall. To filter out particles from the fluid flow, the flow through the element is from the outside to the inside and at the bottom end the filtrate flow passes via a central opening from the shell parts associated with the spherical bearing to the inside of the tank.

Extremely tight tolerances have to be maintained in the manufacture of filter housings and filter housing parts to ensure that the axes of respective element holders of the end caps are precisely aligned with the axes of the housing-side and/or cover-side holding elements, such as connector ends. Manufacturing tolerances in the production of housings, specifically in the case of multi-part housing designs having a plurality of adjacent housing parts, can lead to misalignments which cause distortions in the filter element, resulting in malfunctions or even damage. Filter devices, which accommodate large filter elements in terms of the overall length, are particularly affected by this problem, because here even the smallest angular errors and positional deviations entail large misalignments at the opposite holding element.

This problem is addressed by the technical teaching according to DE 10 2018 009 187 A1 because, due to the filter element being articulated on the element holder via its one end cap by means of a bearing which provides more than one degree of freedom, this provides a compensation option for possible misalignment errors, thus enabling a reduction of the narrow tolerance limits to be complied with for production, and therefore filter devices even with long filter elements or with assembled filter housings can be produced in an operationally reliable manner and at favourable manufacturing costs. In the known solution, the filter element pivotally mounted on the bottom side must be aligned by hand with axial accuracy, for example along the vertical, into an operating or functional position, so that a cover-like connecting socket of the filter head with an outer sealing ring can engage flush in the central centre opening of the upper end cap.

### SUMMARY

A need exists to provide an improved filter element. The need is addressed by the subject matter of the independent claim(s). Embodiments of the invention are described in the dependent claims, the following description, and the drawings.

### BRIEF DESCRIPTION OF THE DRAWINGS

FIG. 1 shows an external view of an example filter element as a tradeable and replaceable assembly;

FIG. 2 shows a view of half of the example filter element according to FIG. 1 in the manner of a longitudinal section;

FIGS. 3 and 4 show an example filter element, in particular according to FIGS. 1 and 2, in the deflected state and the reset state respectively; and

FIG. 5 shows an example foot-end part of the filter element according to FIGS. 1 and 2.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a filter element is provided, wherein an other end part has at least one control surface, which in each case, when not actuated, holds element material in an installation position with respect to a connecting part, as a pivot bearing, and which in each case, when actuated, brings the element material into an operating or functional position with respect to the connecting part by means of a spherical bearing, which position is collision-free for the filter element. The embodiments ensure that the filter element can be aligned virtually automatically via the respective control surface on the filter element when it is installed in one of its functional positions. Thus, when the filter element is installed in a hollow cylindrical filter housing of a type not further specified, the filter element can inevitably assume a corresponding inclined position due to the known spherical bearing at its base, which, unless it is corrected manually in the direction of the vertical functional position, makes it impossible to screw on an associated housing cover or otherwise make a fluid-tight connection between a cover part and other tank or housing parts, because the filter element in its inclined installation position makes the aforementioned connection process difficult or prevents it completely.

However, with the solution according to the teachings herein, when the fluid-tight connection between the cover part and other housing or tank is established, the filter element is automatically aligned in the direction of a vertical alignment axis by means of the respective control surface for operation of the device, so that the filter element always reaches its filtering functional position without the filter element having to be aligned by hand via its bottom-end bearing point, which is not easy to accomplish and can regularly also be forgotten. In particular, the filter element according to the teachings herein can be installed much more easily and quickly.

In some embodiments of the filter element, it is provided that the respective control surface is part of a control body which protrudes axially beyond the element material into the surroundings by a predefinable overhang and which has a predefinable inclination, the angle of inclination of which is selected in such a manner that, when the control body is actuated, the element material assumes its collision-free position, determined for it in each case by the spherical bearing in a self-locking manner. In this way, unobstructed alignment of the filter element into its virtually vertical functional position is always ensured and the inclination of the respective control surface can be selected in such a manner that the alignment process for the filter element as a whole is effectively initiated in a broad area for a wide variety of embodiments of a cover part as part of an overall housing of a type not specified in greater detail. It has been shown that the control body has a control cone towards its free end face, at least one control surface of which control cone forms an acute angle, of for example less than 45°, or for example of approximately 30°, with a longitudinal axis of the element material.

In some embodiments of the filter element, it is provided that the control body is an integral component of an end cap, which has an element holder for accommodating the element material on the end face and that, starting from its inclined control surface, the control body merges into a cylindrical shoulder towards the adjacent upper side of the end cap. This allows the end cap to be manufactured together with the control body in a particularly cost-efficient manner, for example as part of an injection moulding process. Furthermore, the shoulder creates a kind of free surface, which allows parts of the cover to slide off the respective control surface unobstructed, provided that the cover is connected to other tank or housing parts, for example by screwing on.

In some embodiments of the filter element, the control body is penetrated centrally by an opening for the through-flow of fluid, which opening can for example be covered by a valve closing member of a bypass valve, which, accommodated in the interior of the element material, is connected to the adjacent end cap, for example in a lockable manner. In this way, the fluid flow can be directed past and around the filter mat in a kind of bypass or short-circuit mode if the element material is clogged with particle contamination, also referred to in technical terms as blocked, so that a hydraulic circuit connected to the filter element does not immediately have to be taken out of operation for an element change.

As part of fluid guidance, it has proven beneficial for the control body to be penetrated radially by fluid apertures, which open into the surroundings in the form of a fluid space on one side and in the direction of the valve closing member on the other, opposing side. The respective control surfaces of the control body, which define the fluid apertures, can also contribute to a turbulence-free fluid flow through the filter element, particularly with parallel alignment.

In some embodiments of the filter element, it is provided that the control body, arranged coaxial with the longitudinal axis of the element material, protrudes axially beyond the assignable end cap by a predefinable length, which is shorter, for example by half, or for example by one third, than the diameter of the control body at its foot-end transition point to its end cap. In this way, a compact construction of the alignment solution according to the teachings herein may be achieved in the region of the associated upper end cap, so that such filter elements can also be readily used in confined installation conditions.

In some embodiments of the filter element, it is provided that both at least the upper side of the end cap and the control body itself are configured as a ribbed structure with a plurality of individual ribs, and that the inclined individual ribs of the control body form the respective control surface. Due to the ribbed design, a rigid structure is achieved for the associated end cap, which in this respect provides a secure hold for the adjoining element material which is integrated into the end cap.

In some embodiments of the filter element, it is provided that the connecting part of the one end part has a threaded section and a contact surface extending transverse thereto, and that the further end cap of the element material has a further contact surface, which, when pivoted into the functional position by means of the spherical bearing, is partially supported on the one contact surface. This results in a type of counterfeit protection, which is intended to ensure that Original filter elements of the manufacturer cannot be easily cheap counterfeit products which are regularly of low product quality.

For example, it is provided in this case that the spherical bearing of the filter element has a fixable bearing shell on the connecting part, with respect to which a shell part of the end cap having the element material is movably, in particular pivotably, guided.

The filter element is discussed in greater detail below with reference to further embodiments according to the FIGS. The FIGS. are schematic and not necessarily to scale.

Specific references to components, process steps, and other elements are not intended to be limiting. Further, it is understood that like parts bear the same or similar reference numerals when referring to alternate FIGS.

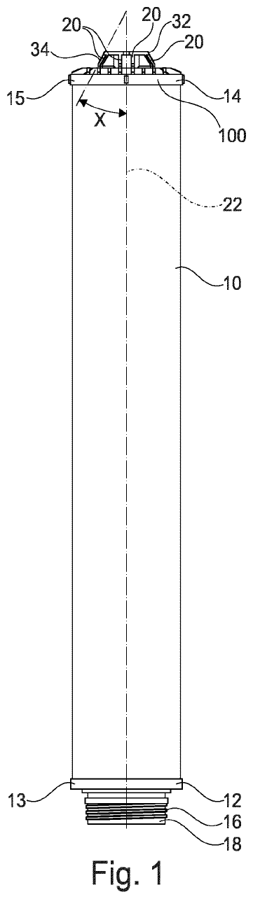

FIG. 1 shows a complete filter element in an external view. The filter element comprises an element material 10, which is used in particular for filtering out particle contamination from a fluid flow. The element material 10 can be pleated as usual, the aforementioned filter pleats being omitted in the FIGS. for the sake of simplicity. In addition, the element material 10 extends between two end parts 12, 14, which are designed in the manner of end caps 13, 15. FIG. 1 shows the filter element as a whole with a vertical setup direction, which corresponds to the usual desired operating or functional position of the filter element, which in turn corresponds to the filtration position.

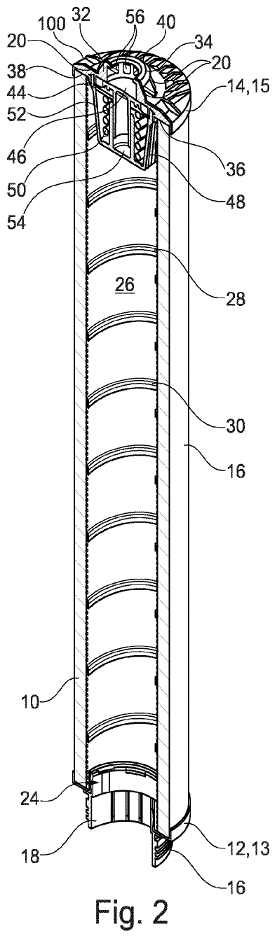

As FIG. 1 further shows, viewed in the direction of FIG. 1, the filter element is provided on its underside with an external thread 16, which is part of a fluid-conducting connecting part 18 in the form of a hollow connecting socket. The upper end part 12 has individual control surfaces 20 which are grouped in a concentric arrangement around the longitudinal axis 22 of the filter element. FIG. 2 shows, in a half longitudinal section through the filter element according to FIG. 1, that the lower end part 14 has a spherical bearing 24 as a whole as well as the fluid-conducting connecting part 18 in the form of the connecting socket with the external thread 16. The hollow cylindrical element material 10 encompasses an interior 26 and is supported on a fluid-permeable supporting tube 28, the individual fluid apertures, for example in the form of a perforation, not being shown for the sake of simplicity. The supporting tube 28 is formed in particular from a strip material, for example sheet metal, which is wound to form a tube, the individual web sections being connected to each other in a fluid-tight manner via a spiral crimping fold 30.

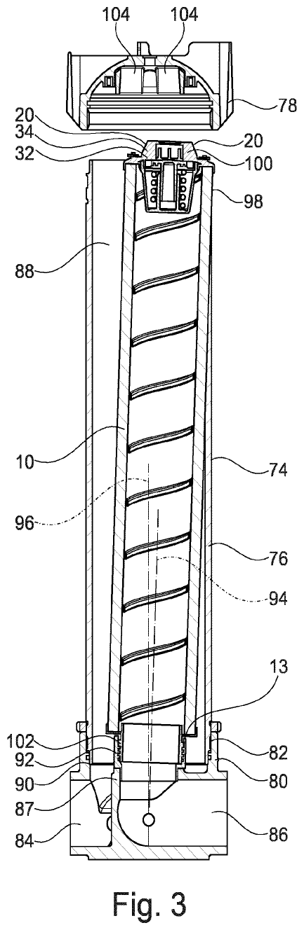

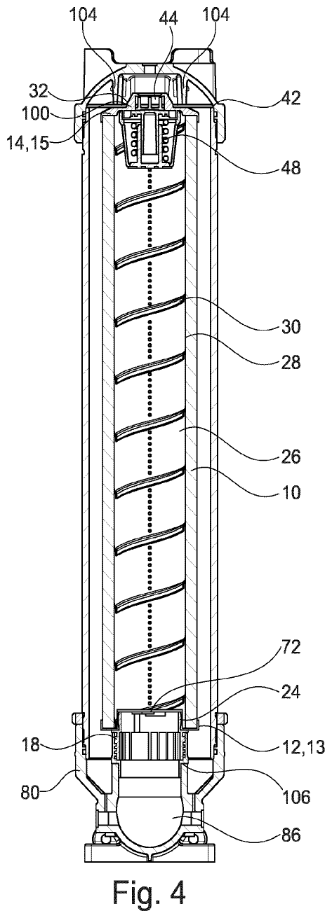

As FIGS. 1 and 2 further show, the respective control surface 20 is a component of a control body 32, which at the end protrudes axially beyond the element material 10 into the surroundings by a predefinable overhang and which has a predefinable inclination, the angle of inclination x of which is selected in such a manner that, when the respective control body 20 is actuated, the element material 10 assumes its collision-free operating or functional position, determined for it in each case by the spherical bearing 24 in a self-locking manner, which can be seen in greater detail from the diagrams according to FIGS. 3 and 4 and is explained in even greater detail below. In this case, the angle of inclination x shown also corresponds to the inclination of the respective control surface 20 with respect to the longitudinal alignment of the element in the form of the longitudinal axis 22. In particular, the control body 32 has a corresponding control cone 34 towards its free end face, the respective control surface 20 of which forms an acute angle, of for example less than 45°, or for example of approximately 30°, with the longitudinal axis 22 of the element material 10.

The control body 32 is an integral component of the upper end cap 15, which in this respect forms the upper end part 14. The aforementioned end cap 15 has an element holder 36 for accommodating the upper free end of the element material 10 on the face end, and the connection between the element material 10 in this upper connection region and the element holder 36 is implemented via a conventional adhesive bed 38, which is not shown for the sake of simplicity. The control body 32 with its individual control surfaces 20 spaced apart from each other opens out at its free end face into an annular surface 40 and, starting from its respectively inclined control surface 20 to the adjacent upper side of the end cap 15, merges into a cylindrical shoulder 42, which can be seen in particular from the diagram according to FIG. 4, although the aforementioned shoulder 42 is not absolutely essential to the function.

The control body 32 is penetrated centrally by an opening 44 for the through-flow of fluid, which opening, according to the diagram of FIG. 2, is covered by a valve closing member 46 of a bypass valve 48 in the closed position thereof. The plate-shaped valve closing member 46 of the bypass valve 48 is supported on a compression spring 50, which is integrated into a receiving housing 52 of the bypass valve 48. According to the diagram of FIG. 2, the flow through the element material 10 is from the outside to the inside towards the interior 26 and, if the element material 10 is clogged by particle contamination, which is referred to in technical terms as blocked, the fluid flow is directed past the element material 10 on the outer circumference and passes in this case to the inner side of the control cone 34 of the control body 32. At the corresponding fluid pressure, the valve closing member 46 is then moved downwards against the force of the compression spring 50, so that in this way this central opening 44 is released and the fluid flow passes via the central opening 44 and via web-like apertures in the receiving housing 52 to the clean side of the element material 10, i.e., into the interior 26 of the filter element. The receiving housing 52 is closed at its base 54 and the valve closing member 46 is guided telescopically via wall parts in adjacent hollow cylindrical wall parts of the receiving housing 52, which otherwise leaves individual apertures free between webs for the through-flow of fluid.

If the upper end part 14 and the receiving housing 52 of the bypass valve 48 are formed from plastic parts, for example in the form of injection-moulded plastic parts, the receiving housing 52 can be locked via its upper edge into corresponding wall parts of the upper end part 14 in an elastically resilient manner for a durable fit, but can also be connected in an adhesive manner. In this case, the bypass valve 48 protrudes into the interior 26 of the element material 10 at its upper free end with an axial overhang as part of the connection. As can further be seen from FIG. 2, the control body 32 is penetrated radially by fluid apertures 56, which open outwardly into the surroundings on one side and exit in the direction of the valve closing member 46 on the other, opposing side. In this case, the individual fluid apertures 56 are defined by web surfaces, which extend vertically between the annular surface 40 and the shoulder 42 and in the direction of the adjacent upper side of the upper end part 14 in the form of the aforementioned end cap 15, and on the outer circumference the individual control webs, which extend outwards from the interior of the control body 32 in a ring-like manner, open into the inclined control surface 20 in each case.

The control body 32 is arranged coaxial with the longitudinal axis 22 of the element material 10 and protrudes axially by a predefinable length beyond the assignable end cap 15 in the form of the upper end part 14, the aforementioned overhang being shorter, for example by one third, than the diameter of the control body 32 at its foot-end transition point to the upper end part 14 in the form of the upper end cap 15. At least the upper side of the aforementioned end cap 15 in the form of the upper end part 14 and also the control body 32 itself with its control cone 34 are configured as a ribbed structure with a plurality of individual ribs, the inclined individual ribs of the control body 32 forming the respective control surface 20. Such a ribbed structure is not absolutely essential but does result overall in stiffening of the upper end part 14, so that setting up forces can be safely absorbed when the filter element is automatically righted, starting from its installation position according to FIG. 3 into its vertical functional position according to FIG. 4. In particular, safe force transmission into the element material 10 of the filter element as a whole is achieved in this way in the region of the control body 32, to which the inner supporting structure in the form of the supporting tube 28, which is integrated into the upper end cap 15 at the end, also contributes

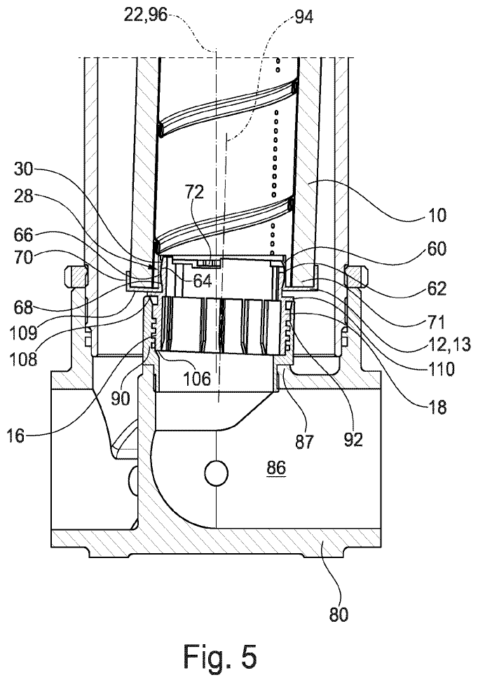

The installation drawing according to FIG. 5 now provides further details below of the spherical bearing 28 as a whole. The lower end cap 13 in the form of the lower end part 12 is pushed with its outer tubular body 60 onto the inner tubular body 62 of the socket-shaped connecting part 18, the bearing 24 being clipped to the abutting bearing surfaces 64, 66 due to elastic resilience, in particular of the tubular body 62 which is free-standing on the contact surface 68. Due to the convex bearing surface 64 resting on the concave bearing surface 66, the spherical bearing 24 is formed in the manner of a ball joint between the lower end cap 13 as part of the lower end part 12 and the connecting part 18 with its external thread 16. The end part 12 forming the lower end cap 13 again has a further element holder 70 for accommodating the lower end of the element material 10, which in this respect is firmly connected to the lower end cap 13 via an adhesive bed 71 which is not shown. In the conventional way, the spherical bearing 24 with its two tubular bodies 60, 62 has a locking device 72, which provides anti-rotation protection when the filter element is screwed into an associated connecting housing between the two tubular bodies 60, 62 and furthermore prevents a predefinable maximum deflection between the two tubular bodies 60, 62 with their spherical bearing surfaces 64, 66 from being exceeded. Further details for an aforementioned locking device can be found by way of example in DE 10 2018 009 187 A1.

As can be seen in particular from the installation situation according to FIG. 3, a housing 74 is provided for the installation of the filter element as a whole, said housing consisting of a hollow cylindrical housing shell 76, said housing shell having at the head end a cover part 78, which has not yet been fitted, in particular is not screwed on, and a fluid guidance part 80 at the foot end, which is already screwed via a threaded section 82 to the outer side of the housing shell 76, at the one lower free end thereof. The fluid guidance part 80 has an inlet 84 for an unfiltered medium flow and an outlet 86 for the filtered filtrate flow. The inlet 84 is connected in a fluid-conducting manner to an unfiltered medium chamber 88 between the inner side of the housing shell 76 and the outer circumferential side of the for example pleated element material 10. After flowing through the element material 10 and the supporting tube 28 from the outside to the inside, the filtrate located on the interior 26 side is discharged as a whole via the outlet 86 of the filter device.

The fluid guidance part 80 has a filter element holder 90 with internal thread 92 in the central region 87 of the outlet 86. The aforementioned socket-like filter element holder 90 is arranged with its central axis 94 offset from the longitudinal axis 96 of the hollow cylindrical housing shell 76 by a predefinable angle, so that in this respect effective installation protection is created as counterfeit protection via the fluid guidance part 80 of the housing 74, and conventional filter elements cannot be inserted into the housing design shown in FIG. 3. In particular, if the cover part 78 is screwed on along an external thread 98 on the upper end of the housing shell 76, the cover part 78 would collide with the upper element end 100 of the filter element, so that in this way it is not even possible to screw on or otherwise connect the cover part 78 to the housing 74.

This is where the present teachings come into play, when a conventional screw-in socket 102, as an integral part of the lower end cap 13 as the lower end part 12, is replaced by an element solution, as shown in FIGS. 1 and 2. In this case, the filter element according to FIGS. 1 and 2 is again brought into an installation position, in which the element is screwed into the inclined filter element holder 90 at the bottom end as counterfeit protection and in this respect an offset then also results between the central axis 94 and the longitudinal axis 96 of the housing shell 76. Accordingly, the upper element end 100 also assumes a position for the element designs according to FIGS. 1 and 2 which is comparable to that shown in FIG. 3.

Now, however, the control body 32 with its control cone 34 already described, which is formed from the individual segmented and inclined control surfaces 20 with the predefinable angle of inclination x, is a component of the element end part 100 according to the teachings herein. If the cover part 78 is now screwed onto the housing shell 76 at the head end, as indicated in FIG. 3, guide parts 104 on the inner circumference of the cover part 78 slide onto the inclined control surfaces 20 and, during the screwing-on movement, this results in a righting movement of the filter element as a whole into its functional position, as shown in FIG. 4, thanks to the spherical bearing 24. To illustrate this, the upper element end of a conventional filter element was replaced by the control body 32 according to the teachings herein. In the aforementioned functional position, the longitudinal axis 96 of the housing shell 76 then extends in a coaxial direction with the central longitudinal axis 22 of the filter element as a whole; with the central axis 94 remaining inclined in relation to the bottom-end filter element holder 90 in the fluid guidance part 80.

The mentioned guide parts 104 in the cover part 78 are for example adapted to the shape of the individual control surfaces 20, so that a vertical orientation is for example obtained in the operating or functional position according to the diagram of FIG. 4. The aforementioned righting movement for the filter element from the installation position according to FIG. 3 into the operating or functional position according to FIG. 4 is carried out virtually automatically and continuously via the said control surfaces 20 of the control body 32 on the upper end cap 15 by progressively screwing on the cover part 78. In particular, the righting movement can for example take place in such a manner that the filter element is aligned in the vertical according to the diagram of FIG. 4 and such that there is an equal radial gap between the outer circumference of the element material 10 and the inner circumference of the housing shell 76. Due to the self-locking, spherical bearing 24, this vertical functional position is also maintained during filter operation.

FIG. 5 already referred to shows the aforementioned installation situation according to FIG. 4 in an enlarged diagram. If, as shown in FIG. 5, the connecting part 18 with its external thread 16 is screwed flush into the internal thread 92 of the filter element holder 90, the connecting part 18 retains an axial distance at its free lower end from an annular shoulder 106 on the filter element holder 90. For the said position shown, the filter element holder 90 has a raised shoulder 106 on the left-hand side viewed in the direction of FIG. 5, which is smaller on the right-hand side, so that the inclined position on the upper side of the filter element holder 90 inevitably arises. On the opposite upper side, the connecting part 18 has a transversely extending contact surface 108 as a closure, which is an integral part of the connecting part 18 and is arranged approximately centrally between the external thread 16 and the tubular body 62 with its convexly extending bearing surface 64. In this respect, the contact surface 108 is widened in diameter compared to the external thread 16 and, when the connecting part 18 is fully screwed into the filter element holder 90, the contact surface 108 is supported with its lower free end on an end-face upper edge 110 of the socket-shaped filter element holder 90 as its upper side.

FIG. 5 again shows in a clearer manner the different arrangements of the axis guides 94; 22, 96 between the components in the operating or functional position. Between the underside of the contact surface 108 and the adjoining external thread 16, there can still be a receiving space 112 for a ring seal, not shown, which separates the unfiltered medium chamber from the filtrate chamber in the interior of the housing 74.

Furthermore, in the operating or functional position shown according to FIGS. 4 and 5, the lower end cap 13, which is pivotably held by means of the pivot bearing or spherical bearing 24, is supported with its contact surface 109 on the inclined upper side of the contact surface 108, so that the end cap 13 with its contact surface 109 is aligned horizontally, which ensures increased stability of the overall structure, in particular during filtration operation and due to this support, the spherical bearing 24 is also relieved of forces during filtration operation. While the lower connecting part 18 is inclined as part of the implementation of installation or counterfeit protection, the spherical bearing 24 compensates for this inclined position and the filter element as a whole is automatically righted from an installation position into an operating position by means of at least one control surface 20 on the opposite element side. This thus has no equivalent in prior art.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually dif-ferent dependent claims or embodiments does not indicate that a combination of these measures cannot be used to advantage. Any reference signs in the claims should not be construed as limiting the scope.

What is claimed is:

1-10. (canceled)

11. A filter element comprising an element material which defines an interior and extends between two end parts, one end part of which has a spherical bearing and a fluid-conducting connecting part which opens out in the direction of the interior, wherein the other end part has at least one control surface, which in each case, when not actuated, holds the element material in an installation position with respect to the connecting part and which in each case, when actuated, brings the element material into a functional position with respect to the connecting part using the spherical bearing, which position is collision-free for the filter element.

12. The filter element of claim 11, wherein the respective control surface is part of a control body which protrudes axially beyond the element material into the surroundings by a predefinable overhang and which has a predefinable inclination, the angle of inclination of which is selected in such a manner that, when the control body is actuated, the element material assumes its collision-free functional position, determined for it in each case by the spherical bearing in a self-locking manner.

13. The filter element of claim 11, wherein the control body has a control cone towards its free end face, at least one control surface of which control cone forms an acute angle, of less than 45°, or of 30°, with a longitudinal axis of the element material.

14. The filter element of claim 11, wherein the control body is an integral component of an end cap, which has an element holder for accommodating the element material on the end face and wherein, starting from its inclined control surface in each case, the control body merges into a cylindrical shoulder towards the adjacent upper side of this end cap.

15. The filter element of claim 11, wherein the control body is penetrated centrally by an opening for the through-flow of fluid.

16. The filter element of claim 11, wherein the control body is penetrated radially by fluid apertures, which open into the surroundings on one side and in the direction of the valve closing member on the other, opposing side.

17. The filter element of claim 11, wherein the control body, arranged coaxial with the longitudinal axis of the element material, protrudes axially beyond the assignable end cap by a predefinable length, which is shorter than the diameter of the control body at its foot-end transition point to its end cap.

18. The filter element of claim 11, wherein both at least the upper side of the one end cap and the control body itself are configured as a ribbed structure with a plurality of individual ribs, and in that the inclined individual ribs of the control body form the respective control surface.

19. The filter element of claim 11, wherein the connecting part of the one end part has a threaded section and a contact surface extending transverse thereto, and wherein the further end cap of the element material has a further contact surface, which, when pivoted into the functional position using the spherical bearing, is partially supported on the one contact surface.

20. The filter element of claim 11, wherein the spherical bearing has a fixable bearing shell with a convex bearing surface on the connecting part, with respect to which a shell part with a concave bearing shell of the end cap with the element material is movably guided.

21. The filter element of claim 12, wherein the control body has a control cone towards its free end face, at least one control surface of which control cone forms an acute angle, of less than 45°, or of 30°, with a longitudinal axis of the element material.

22. The filter element of claim 12, wherein the control body is an integral component of an end cap, which has an element holder for accommodating the element material on the end face and wherein, starting from its inclined control surface in each case, the control body merges into a cylindrical shoulder towards the adjacent upper side of this end cap.

23. The filter element of claim 13, wherein the control body is an integral component of an end cap, which has an element holder for accommodating the element material on the end face and wherein, starting from its inclined control surface in each case, the control body merges into a cylindrical shoulder towards the adjacent upper side of this end cap.

24. The filter element of claim 15, wherein the opening can be covered by a valve closing member of a bypass valve, which, accommodated in the interior of the element material, is connected to the adjacent one end cap.

25. The filter element of claim 15, wherein the opening can be covered by a valve closing member of a bypass valve, which, accommodated in the interior of the element material, is connected to the adjacent one end cap in a lockable manner.

26. The filter element of claim 12, wherein the control body is penetrated radially by fluid apertures, which open into the surroundings on one side and in the direction of the valve closing member on the other, opposing side.

27. The filter element of claim 13, wherein the control body is penetrated radially by fluid apertures, which open into the surroundings on one side and in the direction of the valve closing member on the other, opposing side.

28. The filter element of claim 14, wherein the control body is penetrated radially by fluid apertures, which open into the surroundings on one side and in the direction of the valve closing member on the other, opposing side.

29. The filter element of claim 11, wherein the control body, arranged coaxial with the longitudinal axis of the element material, protrudes axially beyond the assignable end cap by a predefinable length, which is shorter by half than the diameter of the control body at its foot-end transition point to its end cap.

30. The filter element of claim 11, wherein the control body, arranged coaxial with the longitudinal axis of the element material, protrudes axially beyond the assignable end cap by a predefinable length, which is shorter by one third than the diameter of the control body at its foot-end transition point to its end cap.
